(19) United States
(12) Patent Application Publication
(10) Pub. No.: US 2026/0139538 A1
(43) Pub. Date: May 21, 2026

(54) CONCEALED ACTUATOR FOR SWING DOORS

(71) Applicant: Liminal Design Inc., San Jose, CA (US)

(72) Inventors: Stefano Pedemonte, San Jose, CA (US); Alberto Pedemonte, Milan (IT); Carlo Pedemonte, Alessandria (IT)

(21) Appl. No.: 19/451,741

(22) Filed: Jan. 16, 2026

Related U.S. Application Data
(63) Continuation of application No. PCT/US2024/052271, filed on Oct. 21, 2024.
(60) Provisional application No. 63/591,931, filed on Oct. 20, 2023.

(51) Int. Cl. E05F 15/622

(52) U.S. Cl. CPC E05F 15/622; E05Y 2201/626; E05Y 2900/132

(57) ABSTRACT

Provided herein is an actuator for swing doors. An actuator may include a moveable element having a proximal end and a distal end. A distal end may be concealably insertable into a door panel and configured to horizontally rotate the door panel. An actuator may include a base configured to adhere to a door frame. An actuator may include a moveable hinge coupled to a proximal end of a moveable element and a base. A moveable hinge may be configured to pivot with a horizontal rotation of a door panel. An actuator may include an electrical connector concealably positioned behind a moveable hinge relative to an outside view. An electrical connector may pass from a base to a proximal end of a moveable element.

### CROSS-REFERENCE TO RELATED APPLICATIONS

This application is a continuation of International Patent Application No. PCT/US2024/052271, filed Oct. 21, 2024, which claims priority to, and the benefit of, U.S. Provisional Application No. 63/591,931, filed Oct. 20, 2023, the entirety of each of which is incorporated herein by reference.

### TECHNICAL FIELD

The present disclosure relates to doors. In particular, the present disclosure relates to concealed actuators for swing doors and methods of use.

### SUMMARY

Provided herein is an actuator for swing doors. An actuator may include a moveable element having a proximal end and a distal end. A distal end may be concealably insertable into a door panel and configured to horizontally rotate the door panel. An actuator may include a base configured to adhere to a door frame. An actuator may include a moveable hinge coupled to a proximal end of a moveable element and a base. A moveable hinge may be configured to pivot with a horizontal rotation of a door panel. An actuator may include an electrical connector concealably positioned behind a moveable hinge relative to an outside view. An electrical connector may pass from a base to a proximal end of a moveable element.

Provided herein is a method of automatically operating a swing door. A method may include activating a switch element in electrical communication with a moveable element. A moveable element may be concealably inserted into a door panel. A method may include actuating a moveable element in response to activation of a switch element. A moveable element may be connected to a base attached to a door frame through a moveable hinge coupled to the base. A method may include horizontally rotating a moveable element and a moveable hinge relative to a base to cause a door panel to transition between a fully closed position and a fully opened position.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrate an embodiment of a concealed system for door actuation and concealment of electrical wires;

FIGS. 2A-B illustrate embodiments of a concealed system for door actuation and concealment of electrical wires;

FIG. 3 illustrates an exploded view of a concealed system for door actuation and concealment of electrical wires;

FIG. 4 illustrates an embodiment of electrical connections of a concealed system for door actuation and concealment of electrical wires;

FIG. 5 illustrates an embodiment of electrical connections of a concealed system for door actuation and concealment of electrical wires;

FIG. 6 illustrates an embodiment of electrical connections of a concealed system for door actuation and concealment of electrical wires;

FIG. 7 illustrates an embodiment of electrical connections of a concealed system for door actuation and concealment of electrical wires;

FIG. 8 illustrates an exploded view of a concealed system for door actuation and concealment of electrical wires and moveable lever;

FIG. 9 illustrates an embodiment of the shape of a moveable lever that protects fingers of door operators;

FIG. 10 illustrates an exploded view of an embodiment of a concealed system for door actuation and concealment of electrical wires with a moveable lever;

FIG. 11 illustrates various view of a concealed system for door actuation and concealment of electrical wires at various angles;

FIG. 12 illustrates an exploded view of an embodiment of a concealed actuator;

FIG. 13 illustrates an exploded view of another embodiment of a concealed actuator;

FIGS. 14A-B illustrate perspective views of moveable levers with an electric cable;

FIG. 15 illustrates an embodiment of a system for door actuation with an electric cable; and

FIG. 16 is a flowchart of a method of automatically operating a swing door.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that, wherever practicable, similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Aspects of the present disclosure may provide a system of levers for the actuation of doors that can actuate a door panel in both the opening and closing directions and that may be fully concealed when the door is in the closed state and partially concealed in all other door states. Aspects of the present disclosure may provide a system of levers for the actuation which can operate in combination with any hinge by imposing a sufficiently large number of degrees of freedom. Aspects of the present disclosure may provide a system of levers for the actuation of doors that conceal and protect electrical cables. Aspects of the present disclosure may provide a door actuator that can be installed essentially in the same type of milling in the door panel and frame as a common recessed hinge for doors. Aspects of the present disclosure may provide a concealed system for the actuation of doors and for the concealment of electrical wires that can be replaced without need to dismount the door leaf, facilitating the installation and maintenance tasks. Aspects of the present disclosure may provide a door actuator that is highly back-drivable, which means that a user operating the door manually does not perceive the presence of the actuator. Aspects of the present disclosure may provide a door actuator that allows a swing door to open to its full extent of 180 degrees and that can actuate it in this entire range.

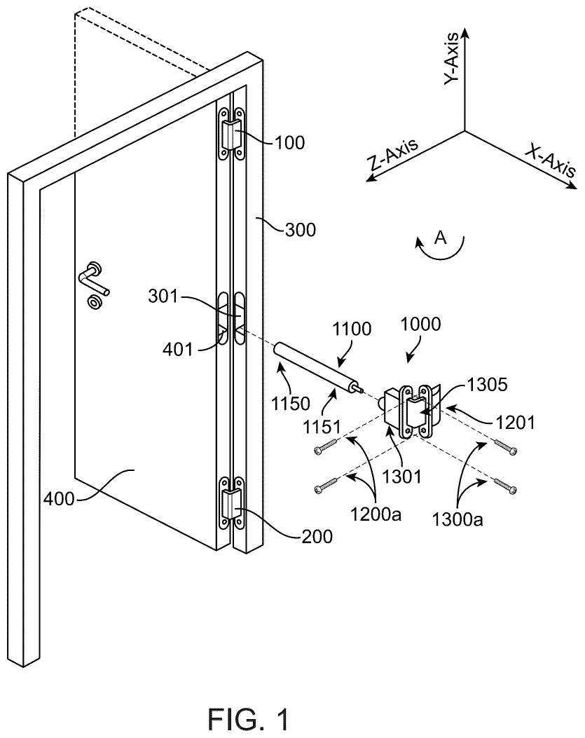

Referring now to FIG. 1, a concealed actuator 1000 is positioned relative to a door. “Concealed” as used throughout this disclosure refers to an invisibility of an object relative to an outside view in a direction of the object. For instance, one or more parts of concealed actuator 1000 may be fully invisible to an individual looking at door panel 400 from any direction when the door is in the closed state. A “door panel” as used in this disclosure refers to a portion of a door moveable to open or close a passageway between the door and a wall of the door. For instance, door panel 400 may be a rectangular shaped object that may connect to a wall via one or more hinges or other connecting mechanisms. When the door is not in the closed position, parts of concealed actuator 1000 may be invisible from a direct line of sight and/or up to angled views of about 180 degrees. All or part of concealed actuator 1000 may be invisible to a user entering or leaving a room door panel 400 may lead to.

Door panel 400 may be made of materials, such as, but not limited to, wood, wood composites, aluminum, fiberglass, steel, and/or other materials. Door panel 400 may be positioned in an office, residential building, or other area. Door panel 400 may have a length of approximately 35 inches, greater than about 35 inches, or less than about 35 inches. Door panel 400 may have a height of about 80 inches, greater than about 80 inches, or less than about 80 inches. Door panel 400 may have a thickness of about 1 inch to about 6 inches, greater than about 6 inches, or less than about 1 inch. Door panel 400 may be a swing door, in some embodiments. Concealed actuator 1000 may include moveable element 1301. A “moveable element” as used in this disclosure refers to a device capable of rotating along an axis and translating on a plane. Moveable element 1301 may be configured to rotate with respect to an Y-axis parallel to door frame 300 and to translate freely within a limited range of motion along ax X-Z plane. In some embodiments, moveable element 1301 may be configured to rotate in direction A or opposite direction A. Moveable element 1301 may be anchored to a linear actuator 1100. Linear actuator 1100 may be a mechanical actuator based on a spring and a hydraulic damper, and/or may include one or more motors, such as, but not limited to, direct current (DC) motors, alternating current (AC) motors, or other types of motors. A linear actuator may include an electric linear actuator, hydraulic linear actuator, pneumatic linear actuator, or other type of linear actuator. A linear actuator may include an electric motor, ball screw, nut, and/or switches and/or sensors. A linear actuator may receive power via a motor, which may spin a screw. A spinning of a screw may force a nut to move along the screw, which may move a sliding element along a straight line, creating linear motion. A reversing of a motor's direction may make a screw rotate in an opposite direction and may cause a sliding element of a linear actuator to move in a direction opposite a first direction. Linear actuator 1100 may have a length of about, but is not limited to, about 1 foot to about 2 feet, greater than about 2 feet, or less than about 1 foot. Linear actuator 1100 may be circular, ovular, rectangular, or other shapes. Linear actuator 1100 may have a diameter of about 1 inch, greater than about 1 inch, or less than about 1 inch.

Moveable element 1301 may be configured to be inserted into door panel 400. Moveable element 1301 may be secured to door panel slot 401 via screws 1201a. Screws 1201a may include a set of screws, such as two or more screws, without limitation. The ensemble composed of moveable element 1301 and linear actuator 1100 may be configured to be inserted into door panel slot 401. Door panel slot 401 may be an interior of door panel 400 that may be carved out or otherwise removed from door panel 400. Door panel slot 401 may be circular, rectangular, or other shapes. Door panel slot 401 may have a width of about 1 inch to about 2 inches, greater than about 2 inches, or less than about 1 inch. Door panel slot 401 may have a length of about 1 foot to about 2 feet, greater than about 2 feet, or less than about 1 foot. A width and/or diameter of door panel slot 401 may be slightly larger than that of moveable element 1301, which may ensure the ensemble of moveable element 1301 and linear actuator 1100 into door panel slot 401. A width of linear actuator 1100 may be slightly smaller than a width of moveable element 1301, which may ensure that linear actuator 1100 remains concealed within the door panel by moveable element 1301. Door panel slot 401 may be positioned in proximity of an axis of rotation of door panel 400. For instance, door panel slot 401 may be positioned halfway at a height of door panel 400. Door panel slot 401 may be offset relative to a center of door panel 400. For instance, door panel slot 401 may be positioned at a left or right of a center of door panel slot 401. An offset of door panel slot 401 relative to a center of door frame 300 may include, but is not limited to, about 0.5 cm to about 2 cm, greater than about 2 cm, or less than about 0.5 cm. In some embodiments, door panel slot 401 is aligned with a center of door panel 400 relative to a side view of door panel 400.

Concealed actuator 1000 may be positioned in combination with two or more door hinges in some embodiments. For instance, and without limitation, a sequence from a top of door panel 400 to a bottom of door panel 400 relative to a Y-axis may be a first hinge, concealed actuator 1000, and a second hinge, a first hinge, a second hinge, then concealed actuator 1000, a first hinge, a second hinge, concealed actuator 1000 and then a third hinge. Door hinges 100 and/or 200 may include any type of door hinge, without limitation, such as, but not limited to, butt hinges, ball bearing hinges, piano hinges, concealed hinges, pivot hinges, and/or barrel hinges. A first door hinge, such as door hinge 100, may connect door panel 400 to door frame 300 at a top portion of door panel 400, while a second door hinge, such as door hinge 200, may connect door panel 400 to door frame 300 at a bottom portion of door panel 400. The door panel slot 401 for positioning the actuator may be placed equidistant from door hinge 100 and door hinge 200, or it may be positioned above, below, or between the door hinges in any order. In some embodiments, door panel slot 401 may be positioned offset relative to the midpoint between the hinges. The offset may range from about 1 inch to about 3 cm closer to door hinge 100 or door hinge 200, or it could be greater than 3 cm or less than 1 inch. In some embodiments, concealed actuator 1000 may be configured to be insertable with any type of door and/or door hinge setup, providing extensive adaptability for diverse hinge configurations. A user may insert concealed actuator 1000 into door panel 400 and/or door frame 300 in an existing door system. To remove concealed actuator 1000 from an existing door system, a user may remove moveable element 1301 and/or linear actuator 1100 from door panel 400 and base 1201 from door frame 300. Removal of moveable element 1301 and/or linear actuator 1100 from the door panel and/or base 1201 from door frame 300 may include a removal of one or more screws attaching base 1201 to door frame 300 and/or moveable element 1301 and linear actuator 1100 to door panel 400.

Linear actuator 1100 may be configured to connect to moveable element 1301 Moveable element 1301 may include one or more levers. Moveable element 1301 may include moveable lever 1305. Moveable lever 1305 may be a lever, in some embodiments. Moveable lever 1305 may be configured to receive a push or pull force from linear actuator 1100, which may translate a linear force created by linear actuator 1100 into a horizontal rotation of movable element 1301, linear actuator 1100, and/or moveable lever 1305. Moveable lever 1305 may connect to moveable element 1301 and/or base 1201. Base 1201 may be a stationary device which may resist forces created by linear actuator 1100, which may cause door panel 400 to rotate. A reaction of two or more hinges 100 and 200 to a force created by linear actuator 1100 and imposed on base 1201 may create a torque about an axis of rotation of the hinges between moveable element 1301 and base 1201. A torque may be created between door panel 400 and door frame 300. A torque may be relative to a Z-axis, which may run along horizontally from the floor plane with and in parallel to door frame 300. By creating a torque, a movement of rotation of door panel 400 with respect to door frame 300 around a rotation axis imposed by the hinges may result. Torques applied to door panel 400 by linear actuator 1100 may be in a range of, but are not limited a range of, about 1 Nm to about 50 Nm, greater than about 50 Nm, or less than about 1 Nm.

Moveable element 1301 may be configured to horizontally rotate. “Horizontal rotation” as used in this disclosure refers to a rotation of an object about a vertical axis. For instance, an object may rotate about a Y-axis, which may be parallel to a wall at specific rotational speeds in degrees per second, such as, but not limited to, about 10 degree per second to about 30 degrees per second, greater than about 30 degrees per second, or less than about 10 degree per second. In some embodiments, a rate of change of degrees per second of moveable element 1301 may be constant. In other embodiments, a rate of change of degrees per second of moveable element 1301 may vary between transitioning door panel 400 from an open position to a closed position. For instance, an initial or first rate of change of degrees per second of moveable element 1301 may be about 5 degrees per second, but may increase to a second rate of change in degrees per second of about, but limited to, 20 degrees per second when door panel 400 arrives at a maximum speed, and may decrease to a rate of change in degrees per second of about 5 degrees per second when the door panel 400 nears a closed position. One or more processors of concealed actuator 1000 may be programmed to calculate a closed position of door panel 400 and/or an open position of door panel 400 based on sensor data, such as, but not limited to proximity sensor data, sensors measuring the displacement of linear actuator 1100, and/or sensors sensing the relative or absolute rotational position of a motor driving the linear actuator 1100. In some embodiments, one or more processors of concealed actuator 1000 may automatically calculate closed position of door panel 400 and/or open position, closing torque and opening torque, closing acceleration and opening acceleration of door panel 400 based on a length and weight of door panel 400, which may be provided to the one or more processors via user input and/or external computing devices or may be estimated by the processors automatically. Based on a length of door panel 400, one or more processors of concealed actuator 1000 may calculate a closed position of door panel 400, an open position of door panel 400, an amount of torque required to horizontally rotate door panel 400, a rate of change in degrees per second to transition door panel 400 between closed and open positions, and/or any other parameters.

Referring still to FIG. 1, base 1201 may be made of metal, plastic, or other materials. Base 1201 may be insertable in door frame slot 301. Base 1201 may be secured to door frame slot 301 via screws 1301a. Screws 1301a may include a set of two or more screws. Base 1201 may be inserted into door frame slot 301 by about, but not limited to, about 1 inch, greater than about 1 inch, or less than about 1 inch. In some embodiments, base 1201 may include an anchoring end. An anchoring end may be a long rod shaped material that may be inserted into door frame slot 301, which may mirror that of moveable element 1100 within door panel slot 401. Door frame slot 301 may be rectangular, circular, or other shapes. Door frame slot 301 may have a width about 1½ inches, greater than about 1½ inches, or less than about 1½ inches. Door frame slot 301 may have a height of about 3 inches, greater than about 3 inches, or less than about 3 inches. Door frame slot 301 may have a length of about 1 inch, greater than about 1 inch, or less than about 1 inch. In some embodiments, door frame slot 301 may be positioned at the same height as door panel slot 401 relative to a height of a ground surface. For instance and without limitation, both door frame slot 301 and door panel slot 401 may be positioned at about half a height of door panel 400. In some embodiments, door panel slot 401 and door frame slot 301 may have the same dimensions, such as, but not limited to, heights, widths, and/or thicknesses. In other embodiments, dimensions between door panel slot 401 and door frame slot 301 may differ. In some embodiments, a length of door panel slot 401 may be longer than a length of door frame slot 301 to accommodate one or more levers of concealed actuator 1000.

Referring still to FIG. 1, moveable element 1301 may be configured to horizontally rotate between about 0 degrees to about 180 degrees relative to base 1201 and/or door frame 300. A “horizontal rotation” as used in this disclosure refers to a change in angle of an object with respect to an axis. Axes may include, but are not limited to, X-axis, Y-axis, and/or Z-Axis. In some embodiments, moveable element 1301 may be configured to rotate greater than about 180 degrees relative to door frame 300. Moveable element 1100 may rotate door panel 400 from a first open position to a second open position. A first open position may be a position in which door panel 400 is about 90 degrees to about 180 degrees rotated from door frame 300, or is otherwise perpendicular to door frame 300. A second open position may be a position in which door panel 400 is rotated about −90 degrees to about −180 degrees relative to door frame 300, or otherwise perpendicular to door frame 300. A horizontal rotation of moveable element 1301 may cause door panel 400 to horizontally rotate with moveable element 1301. For instance, moveable element 1301 may provide a force, such as, but not limited to, a torque, to door panel 400 from within door panel 400, such as door panel slot 401. A force provided by moveable element 1301 may cause a force to be applied to hinges 100 and/or 200, which may allow for a rotation of door panel 400. A rotation of moveable element 1301 may cause door panel 400 to rotate between a fully closed position and a fully open position. A fully closed position may be a position in which door panel 400 is horizontally axially aligned with door frame 300, for instance if door panel 400 is parallel to door frame 300. For instance, door panel 400 may fit inside door frame 300. Door panel 400 may have a length slightly smaller than that of door frame 300, which may allow door panel 400 to fit inside of door frame 300. In some embodiments, door panel 400 and door frame 300 may have a same width, which may allow for a flush appearance of door panel 400 in a fully closed position within door frame 300. In other embodiments, door panel 400 and door frame 300 may have differing widths. A fully open position may be a position in which door panel 400 is aligned perpendicular to door frame 300. For instance, a fully open position may be a position in which door panel 400 is positioned at 90 degrees or −90 degrees relative to a horizontal axis of door frame 300.

Moveable element 1301 may be configured to move with an external force provided to door panel 400. An external force may include a torque provided on door panel 400 by an individual or other entity. In some embodiments, moveable element 1301 may resist an external force provided to door panel 400. For instance, concealed actuator 1000 may have one or more processors that may be programmed to resist torques from an external force. One or more processors of concealed actuator 1000 may be programmed to resist external forces once door panel 400 is in a fully open position. In some embodiments, one or more processors of concealed actuator 1000 may be programmed to resist external forces once door panel 400 is in a fully closed position. One or more processors of concealed actuator 1000 may be programmed to resist external forces once door panel 400 is positioned in any angle relative to door frame 300, without limitation. Concealed actuator 1000 may resist one or more external forces by applying an equal and opposite force in a direction of the one or more external forces via moveable element 1301. As a non-limiting example, an individual may try to close door panel 400 by applying a torque to door panel 400, which may cause concealed actuator 1000 to apply an equal and opposite torque through a horizontal rotation of linear actuator 1100. Furthermore, the processor of concealed actuator 1000 is capable of detecting if a person is interacting with the door. Upon detection of such interaction, the processor may adjust the actuator's operation by either switching to manual operation mode, decreasing the actuation torque to allow easier manual movement, or performing another suitable action to ensure user safety and ease of use.

In some embodiments, one or more processors of concealed actuator 1000 may be programmed to position door panel 400 in a fully open or fully closed position in emergency situations, which may be conveyed to one or more processors of concealed actuator 1000 via a wireless communication unit of concealed actuator 1000.

Referring still to FIG. 1, in some embodiments, concealed actuator 1000 may be in communication with a switch element. A “switch element” as used in this disclosure is any hardware or software capable of providing a binary output. Switch elements may include, but are not limited to, toggles, capacitive buttons, butterfly buttons, and/or other types of switch elements. Switch elements may be provided within a proximity of concealed actuator 1000. In some embodiments, a switch element may include an icon on a graphical user interface (GUI) of a computing device. Computing devices may include, but are not limited to, desktops, laptops, smartphones, tablets, and/or other devices. Concealed actuator 1000 may include one or more wireless communication devices, such as, but not limited to, Bluetooth chips, Wi-Fi chips, Cellular chips, and/or other types of wireless communication devices. For instance, a user may be able to form a wireless connection with concealed actuator 1000 through a Bluetooth, Wi-Fi, or other connection. A user may operate concealed actuator 1000 remotely through operation of one or more computing devices and/or switch elements. In some embodiments, a proximity sensor may be used. A proximity sensor may include, but is not limited to, infrared, laser, radar, and/or other types of proximity sensors. A proximity sensor may be in wireless or wired communication with concealed actuator 1000. One or more processors of concealed actuator 1000 may activate moveable element 1100 based on data generated by one or more proximity or other sensors. For instance, data generated by a proximity sensor may include a specific distance between an individual and door panel 400. One or more processors of concealed actuator 1000 may be programmed to trigger moveable element 1100 for specific detected distances of an individual, such as, but not limited to, about 5 meters away, about 4 meters away, about 3 meters away, about 2 meters away, about 1 meter away, or less than about 1 meter away. In some embodiments, concealed actuator 1000 may receive user input through a user interface (UI) or via one or more computing devices. In some embodiments, a user or other operator may deactivate concealed actuator 1000 via a wired or wireless interactive element, such as a button, smartphone application, or other interactive element to allow door panel 400 to be operated manually. In some embodiments, a microphone may be used to detect one or more voice commands which may be used to operate concealed actuator 1000. In some embodiments, a camera, and/or or other sensor, including but not limited to a range sensor, including but not limited to a time-of-flight sensor, and optical sensor, an electromagnetic sensor, a radar, or an ultrasound sensor, may be used to detect one or more gestures of a user and to detect the location and approaching speed and trajectory of door users to inform the operation of concealed actuator 1000 that may be used to operate system. One or more sensors may be placed on door panel 400 and/or on a wall in a proximity of door panel 400.

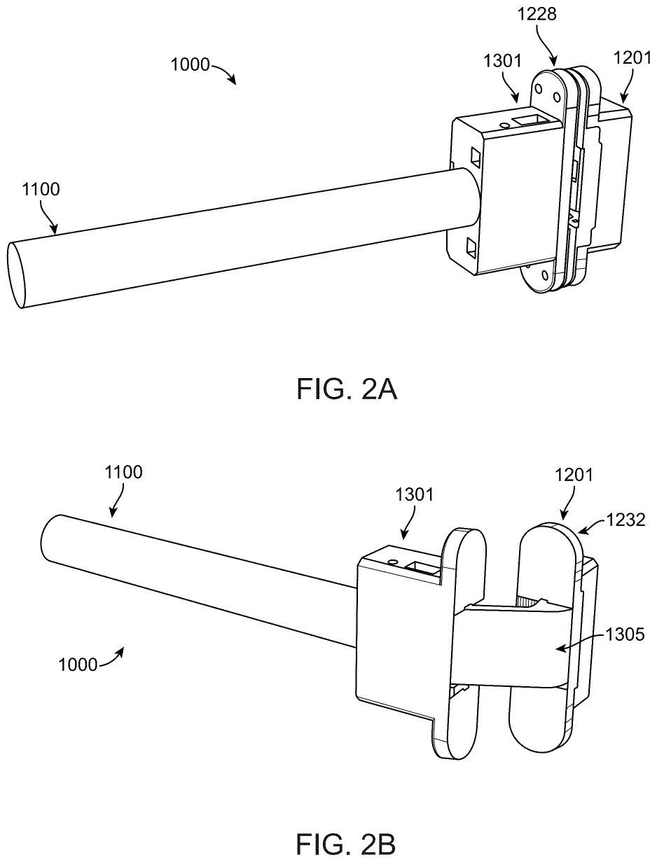

Referring now to FIG. 2A, a side perspective view of concealed actuator 1000 in a closed position is shown. Concealed actuator 1000 may include moveable element 1100, which may be partially housed within moveable element connector 1301. For instance, moveable element connector 1301 may include a circular or other shaped slot that may partially house proximal end 1151. Moveable element connector 1301 may be rectangular or other shapes. In some embodiments, moveable element connector 1301 may have a width of about 3 cm to about 5 cm, a width greater than about 5 cm, or a width less than about 3 cm. In some embodiments, moveable element connector 1301 may have a height of about 2 cm to about 3 cm, greater than about 4 cm, or less than about 2 cm. Moveable element connector 1301 may have a length of about 2 cm to about 4 cm, greater than about 4 cm, or less than about 2 cm. Moveable element connector 1301 may be made of a metal or plastic material. In some embodiments, moveable element connector 1301 may have securing ends 1228. Securing ends 1228 may extend outwards from an end of moveable element connector 1301. For instance, securing ends 1228 may extend from a top and bottom end of moveable element connector 1301. Securing ends 1228 may be configured to secure to a portion of a door panel, such as door panel slot 401 as described above with reference to FIG. 1. In some embodiments, securing ends 1228 may be secured to a door panel through one or more securing elements. Securing elements may include screws or other elements. Base 1201 may have securing ends 1232. Securing ends 1232 may extend outwards from a top and/or bottom portion of base 1201. Securing ends 1232 may be configured to secure base 1201 to a door frame, such as door frame slot 301 as described above with reference to FIG. 1. Securing ends 1232 may be configured to secure to a door frame via one or more securing elements, such as, but not limited to, screws. In some embodiments, no more than 4 screws may be needed to integrate concealed actuator 1000 in a door panel and/or door frame. For instance, a set of two screws may be used with securing ends 1228 and a set of two screws may be used with securing ends 1232. Securing ends 1228 and/or 1232 may be rectangularly or other shaped. Securing ends 144 and/or 212 may be shaped to connect flushly to door panel slot 401 and door frame slot 301. In some embodiments, securing ends 1228 and 1232 may have differing dimensions. An entirety of concealed actuator 1000 may have a length of about, but not limited to, about 1 foot to about 2 feet, greater than about 2 feet, or less than about 1 foot.

Referring now to FIG. 2B, a side perspective view of concealed actuator 1000 in an open position is shown. Moveable element connector 1301 may be connected to base 1201 via moveable hinge 1305. Moveable hinge 1305 may be configured to receive a push or pull force from moveable element 1100 and rotate horizontally with respect to base 1201, which may cause door panel 400 to rotate horizontally. Moveable hinge 1305 may be made of metal, plastic, or other materials. Moveable hinge 1305 may have a length of about, but not limited to, about 3 cm to about 5 cm, greater than about 5 cm, or less than about 3 cm. Moveable hinge 1305 may have a width of about, but not limited to, about 3 cm to about 5 cm, greater than about 5 cm, or less than about 3 cm. Moveable hinge 1305 may have a curvature. Moveable hinge 1305 may form an “L” shape. For instance, moveable hinge 1305 may have a curvature along it's length. A curvature of moveable hinge 1305 may be about, but not limited to, about 0 degrees to about 180 degrees, without limitation. Moveable hinge 1305 may be curved at one end or both ends. For instance, a connection between moveable element 1100 and moveable hinge 1305 may be curved and/or a connection between moveable element 1100 and base 1201 may be curved. In some embodiments, moveable hinge 1305 may be made of one or more connecting segments. Each segment of a connecting segment may be rotatably coupled to a preceding and/or subsequent segment of a plurality of segments. A plurality of segments may be used to allow moveable hinge 1305 to more freely rotate with respect to a single solid piece.

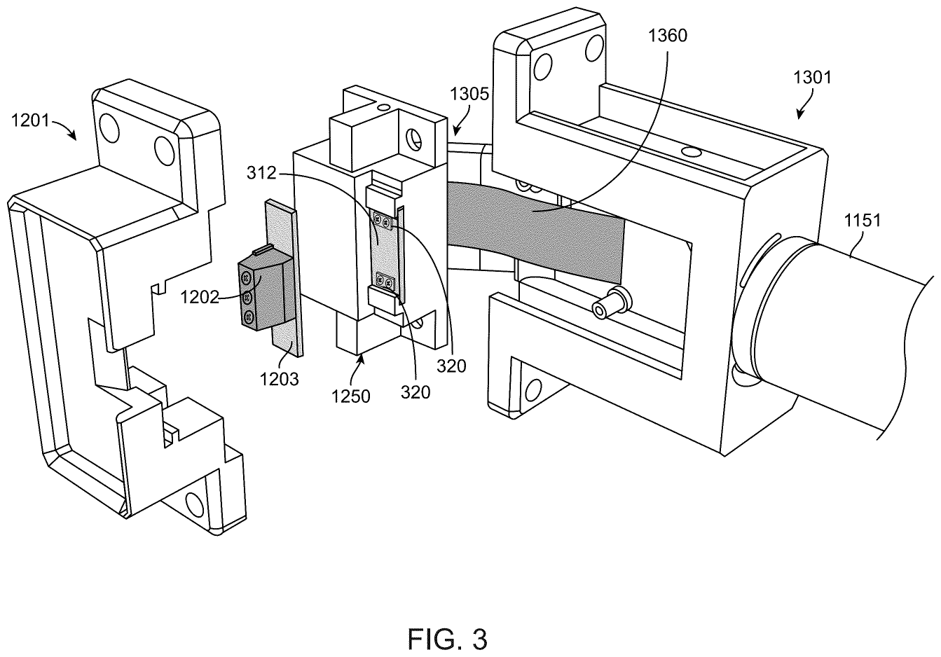

Referring now to FIG. 3, an exploded view of concealed actuator 1000 is presented. Concealed actuator 1000 may include base 1201. In some embodiments, concealed actuator 1000 may include moveable element connector 1301, which may be the same as moveable element connector 1301 as described above with reference to FIGS. 1-2B. Moveable element connector 1301 may be adapted to partially receive proximal end 1151 of moveable element 1100. Moveable element connector 1301 may house one or more electrical and/or mechanical components. In some embodiments, moveable element connector 1301 may include electrical connector 1360. Electrical connector 1360 may be configured to electrically connect moveable element 1100 to one or more power sources. Electrical connector 1360 may be a thin rectangular shape. In some embodiments, electrical connector 1360 may pass through a window of moveable element connector 1301 and/or base 1201, which may allow electrical connector 1360 to be tightly interwoven between moveable element connector 1301 and base 1201. Electrical connector 1360 may be about 6 cm to about 10 cm, greater than about 10 cm, or less than about 6 cm. Electrical connector 1360 may provide power to moveable element 1100 from a power source. Power sources may include, but are not limited to, batteries, power grids, and/or other power sources. Electrical connector 1360 may provide voltages of between 1V to about 240V and/or currents of about 1 A to about 20 A.

Electrical connector 1360 may be configured to provide data, such as digital data, analog data, and/or control data. Digital data may include binary data or bits, such as 0's and/or 1's. Analog data may include continuous signals or waveforms, such as sine, cosine, tangent, or other waveform types. Control data may include data instructing Electrical connector 1360 may have a plurality of electrical wires running in parallel with one another along a length of electrical connector 1360. A plurality of electrical wires may be made of, but not limited to, copper, silver, aluminum, gold, or other materials. A plurality of electrical wires may include 2 or more electrical wires. A plurality of electrical wires of electrical connector 1360 may be encased in a protective material. Protective materials may include, but are not limited to, mylar, PVC, or other materials. In some embodiments, electrical connector 1360 may be made of a protective material, such as, but not limited to, mylar, PVC, or other materials. Electrical connector 1360 may be flexible, and may be adapted to twist and/or turn with a movement of moveable hinge 128. Electrical connector 1360 may be configured to rotate with moveable hinge 1305.

In some embodiments, electrical connector 1360 may be concealably positioned behind moveable hinge 1305. For instance, when in operation, electrical connector 1360 may be invisible to an outside perspective view, such as from an individual looking in a direction of concealed actuator 1000. A first end of electrical connector 1360 may be electrically connected to moveable element 1100 and/or one or more processors. A second end of electrical connector 1360 may be electrically connected to printed circuit board (PCB) 1364. PCB 1364 may include one or more processors, capacitors, transistors, resistors, transformers, integrated chips, system on chip (SoC), and/or other electrical devices. PCB 1364 may include power management circuitry which may control an amount of voltage and/or current delivered to moveable element 1100. Power management circuitry may include, but is not limited to, voltage regulators, DC-DC converters, AC-DC converters, DC-AC converters, power factor correction circuits, current sensing circuits, and/or other types of circuits. PCB 1364 may be configured to connect to terminal block 1202 via contact pads 1360a. Contact pads 1360a may be any type of electrical contact. Terminal block 1202 may be configured to connect to an external power source, such as, but not limited to, batteries power grids, AC sources, DC sources, and/or other power sources. Terminal block 1202 may receive power and transfer power to moveable element 1100 via electrical connector 1360. Terminal block 1202 may include a form of insulation, such as, but not limited to, polymers, plastics, and/or other materials. Terminal block 1202 may be connected to terminal PCB 1203. Terminal PCB 1203 may include one or more resistors, capacitors, SoC's, integrated chips, and/or other devices. Terminal PCB 1203 may be configured to convert power from a power source into power usable by moveable element 1100, such as by adjusting voltages and/or currents of a power source. Terminal PCB 1203 may connected to PCB 1364 via contact pads 1360a. In some embodiments, PCB 1364 may have a set of contact pads 1360a, such as, but not limited to, sets of two or more contact pads 1360a.

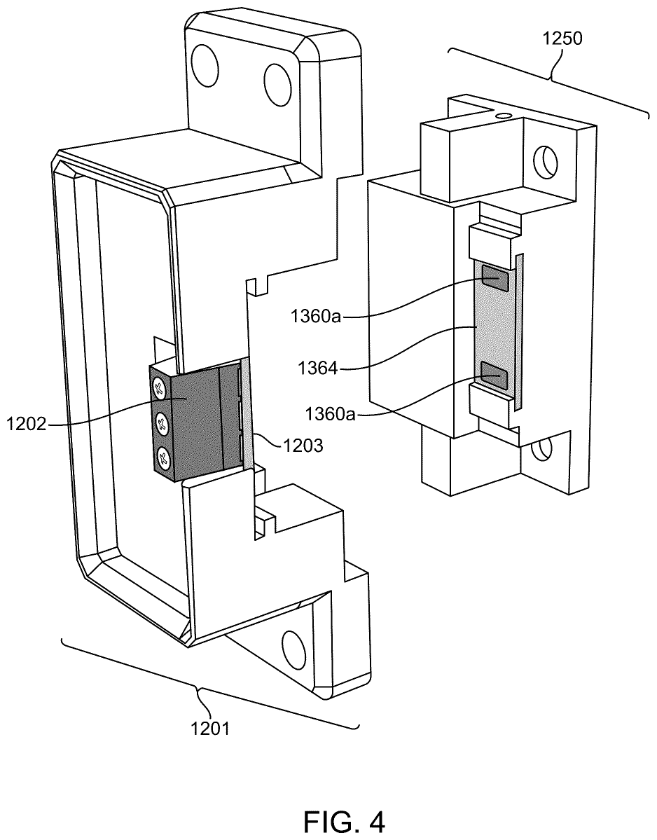

Referring now to FIG. 4, an embodiment of electrical connectors of a moveable element is presented. Base 1201 may include terminal block 1202 and/or terminal PCB 1203. Moveable element electrical connector 1250 may include PCB 1364 and/or contact pads 1360a. Contact pads 1360a may be any type of electrical contact, without limitation. Contact pads 1360a may be configured to electrically connect electrical connector 1360 to moveable element 1100, in some embodiments. Contact pads 1360a may include a set of electrical contacts, such as two or more electrical contacts. In some embodiments, a set of contact pads 1360a may include a first electrical contact positioned at top of PCB 1364 and a second electrical contact positioned at a bottom of PCB 1364. Contact pads 1360a may be square, circular, or other shapes. Contact pads 1360a may be made of copper, aluminum, silver, gold, or other materials.

Referring still to FIG. 4, terminal block 1202 may include one or more electrical outlets. One or more electrical outlets of terminal block 1202 may be configured to connect to an external power source, such as, but not limited to, batteries, power grids, AC sources, DC sources, and/or other sources. Terminal block 1202 may have a plurality of electrical outlets. In some embodiments, terminal block 1202 may have three or more electrical outlets. Terminal block 1202 may be configured to connect to a power supply of a building in which concealed actuator 1000 may be positioned. Wires connecting a power source to electrical outlets of terminal block 1202 may be hidden within a wall of door panel 400. In some embodiments, all electrical wires of concealed actuator 1000 may be hidden from view of an individual looking in a direction of concealed actuator 1000.

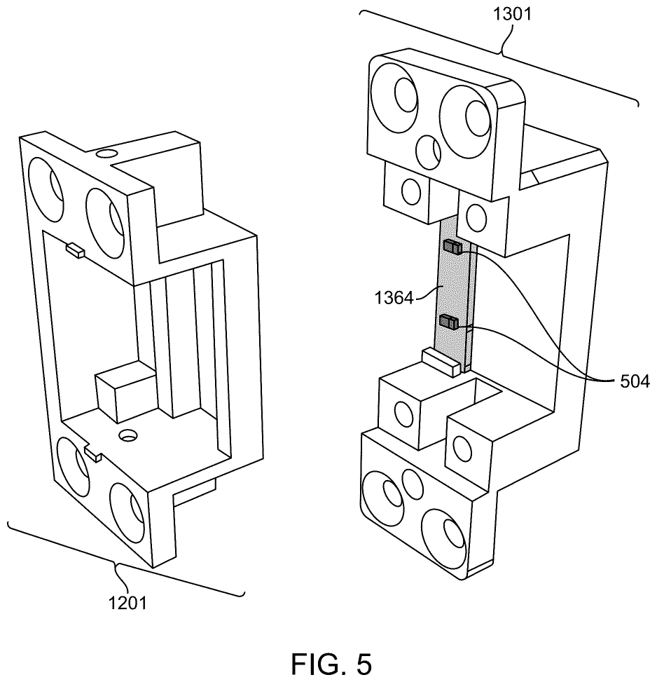

Referring now to FIG. 5, an embodiment of electrical connectors is presented. Moveable element connector 1301 may include moveable element connector 1301 which may include spring contacts 504 electrically connected to PCB 1364. Spring contacts 504 may provide a spring force outwards from moveable element connector 1301. A cable or other electrical connection device, such as electrical connector 1360, may be able to form an electrical connection via spring contacts 504. An electrical connection formed via spring contacts 504 may allow for a disassembly of concealed actuator 1000 without to disconnect any cables via the use of spring contacts 504.

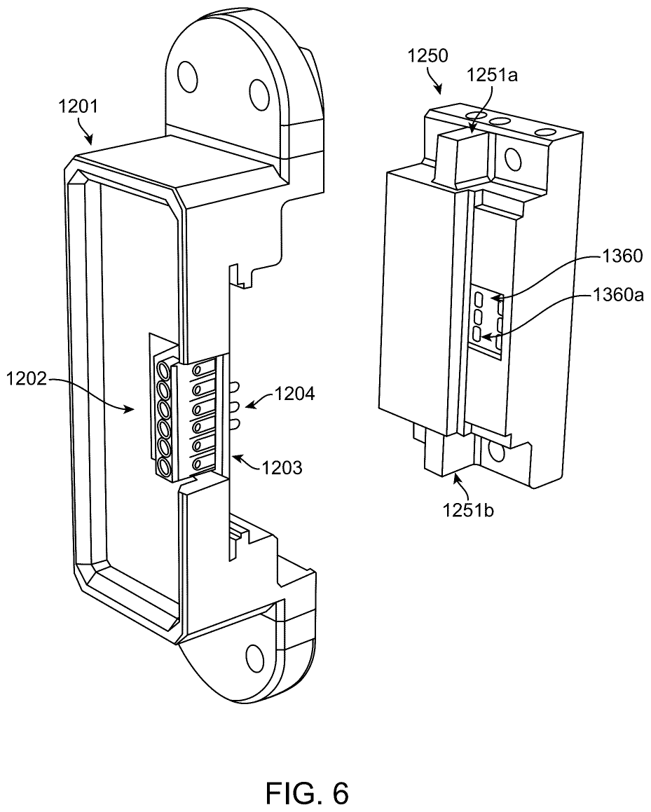

Referring now to FIG. 6, a front perspective view of an embodiment of electrical contacts is presented. Base 1201 may include terminal block 1202. Terminal block 1202 may be electrically connected to spring pins 1204 of PCB 1203. Spring pins 1204 may be adapted to come into contact with contact pads 1360a of moveable element electrical connector 1250. Contact pads 1360a may be electrically connected to cable 1360 and/or a PCB electrically connected to cable 1360. Moveable element electrical connector 1250 may include protrusions 1251a and 1251b which may be configured to mate with one or more recesses of base 1201.

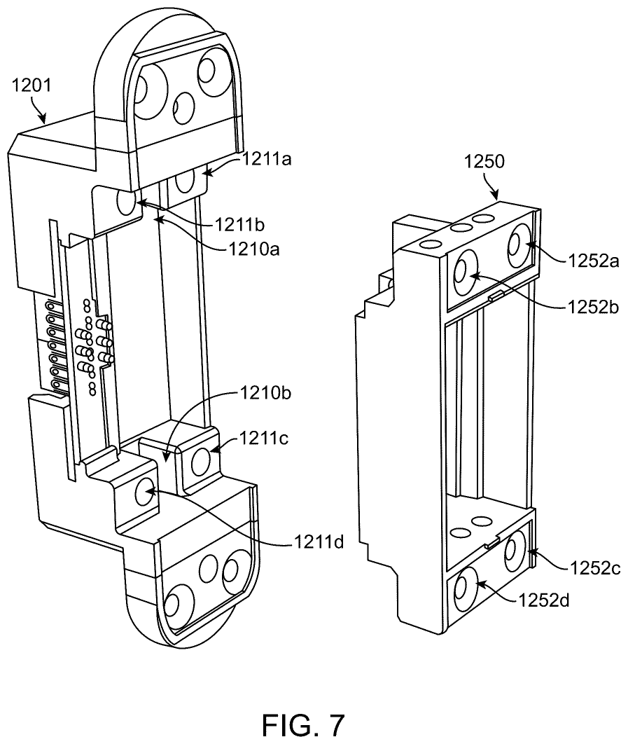

Referring now to FIG. 7, a rear perspective view of the embodiment of FIG. 6 is presented. Base 1201 may include screw sockets 1211a and/or 1211b on first recess 1210a and screw sockets 1211c and 1211d on second recess 1210b. Moveable element electrical connector 1250 may include screw sockets 1252a, 1252b, 1252c, and/or 1252d. Base 1201 and moveable element electrical connector 1250 may be configured to couple together view protrusions 1251a, 1251b, recess 1210a, 1210b, and/or screw sockets 1211a, 1211b, 1211c, 1211d, 1252a, 1252v, 1252c, and/or 1252d.

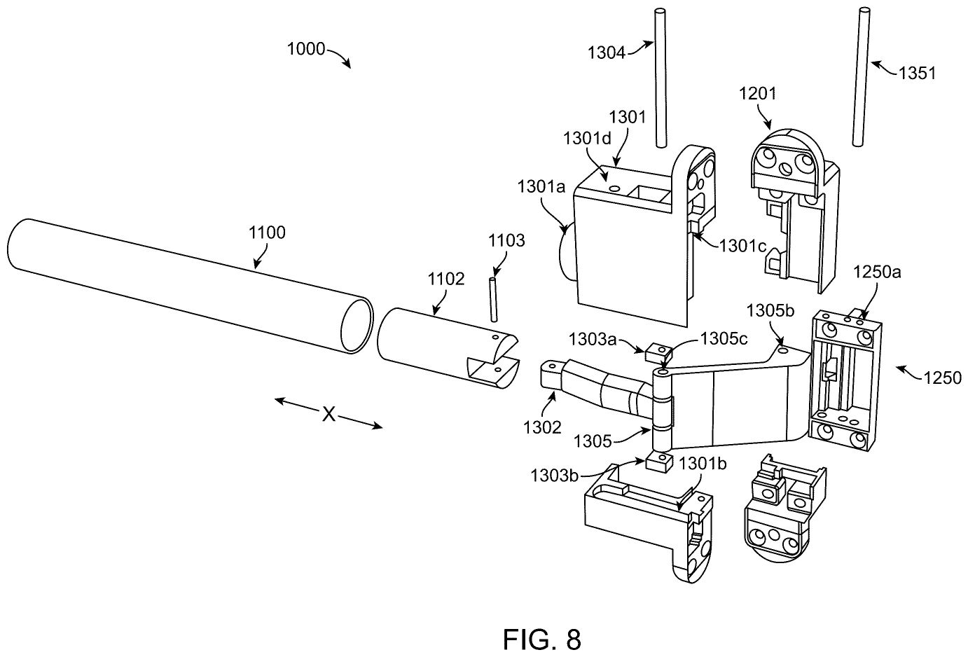

With reference to FIG. 8, an exploded view of concealed actuator 1000 is presented. Concealed actuator 1000 may include levers box 1301 (also referred to as “moveable element connector”), which may house push-pull lever 1302 (also referred to as “first lever 1302”), actuation lever 1305 (also referred to as “second lever 1305”), sliders 1303a and 1303b, and/or pins 1103 and 1304.

Concealed actuator 1000 may include linear actuator 1101. Linear actuator 1101 may transmit a force to levers 1302 and/or 1305 through a linear movement of sliding element 1102. For instance, sliding element 1102 may be configured to slide in direction X. Direction X may be parallel to a direction of a door width. Linear actuator 1101 may guide sliding element 1102 along a linear path. A linear path may include a path within a body of linear actuator 1101, which may be along direction X. For instance, sliding element 1102 may slide at least partially within linear actuator 1101. Linear actuator 1101 and/or sliding element 1102 may be cylindrically shaped. Sliding element 1102 may have a diameter slightly less than a diameter of linear actuator 1101, which may allow sliding element 1102 to move within linear actuator 1101.

Push and pull forces generated by linear actuator 1101 may be transmitted to first lever 1302. First lever 1302 may be integral to sliding element 1102. For instance, first lever 1302 may be directly coupled to sliding element 1102. In some embodiments, first lever 1302 may be connected to sliding element 1102 through joint 1103. Joint 1103 may be a rotating joint. An end of first lever 1302 opposite to sliding element 1102 may be constrained to move along a linear path which may be parallel to the direction of motion of linear actuator 1101 or at an angle to a direction of motion of linear actuator 1101. A motion of linear actuator 1101 and/or sliding element 1102 may be constrained to occur along a linear path by sliding elements 1303a and/or 1303b. For instance sliding element 1303a and/or sliding element 1303b may prevent a vertical movement of linear actuator 1101 and/or sliding element 1102 by providing a force opposite to a vertical movement of linear actuator 1101 and/or sliding element 1102. Sliding element 1303a may slide within guide rail 1301c and sliding element 1303b may slide within guide rail 1301c. Guide rails 1301a,c, may be connected to sliding elements 1303a,b, by one or more joints. For instance, a joint may include cylindrical pin 1304. Cylindrical pin 1304 may be inserted into 1301, such as through opening 1301d. Sliding elements 1303a and/or 1303b may allow for a linear movement of second lever 1305, such as in direction X.

A sliding end of first lever 1302 may be connected to second lever 1305 through a joint, such as a rotating joint. In some embodiments, a sliding end of first lever 1302 may be connected to second lever 1305 through pin 1304, which may act as a joint, allowing second lever 1305 to rotate with respect to first lever 1302. Linear motion of first lever 1302 may result in a linear motion of one end of second lever 1305. At an end of second lever 1305 opposite first lever 1302, a rotating joint may connect second lever 1305 to actuator body element 1250. Actuation body element 1250 may be anchored rigidly to a door frame, wall, or other fixture. A rotating joint connecting second lever 1305 to actuator body element 1250 may include cylindrical pin 1351. Cylindrical pin 1351 may be inserted into holes 1305b and/or 1250b of second lever 1305 and actuator body 1250, respectively. A number of degrees of freedom of body element 1250 with respect to levers box 1301 may be about 3, greater than 3, or less than 3. An axis of rotation of concealed actuator 1000 may be created by second lever 1305 and/or first lever 1302, rather than imposing an axis of rotation on a door. A retraction of first lever 1302 towards linear actuator 1101 may cause a door panel to close, while a force that pushes first lever 1302 away from linear actuator 1101 may cause a door panel to open.

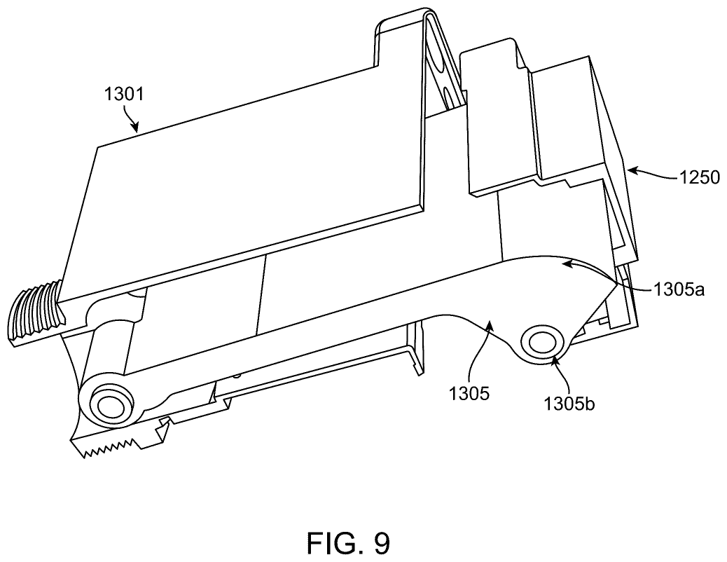

With reference to FIG. 9, a perspective side view of a moveable element connector 1301 is presented. Second lever 1305 may be positioned within actuator body element 1250 and moveable element connector 1301 tightly. For instance, a space between each of second ever 1305 and actuator body element 1250, and a space between actuator body element 1250 and moveable element connector 1301, may be less than about 18 mm to about 22 mm. A distance of less than about 18 mm to about 22 mm may prevent a user's fingers from fitting within any part of second lever 1305. Second lever 1305 may include curved section 1305a. Curved section 1305a may be designed to prevent insertion of a user's finger between second lever 1305 and moveable element connector 1301 and/or actuator body element 1250. Curved section 1305a may have an angle of about, but not limited to, about 10 degrees to about 180 degrees of curvature along a length of curved section 1305a.

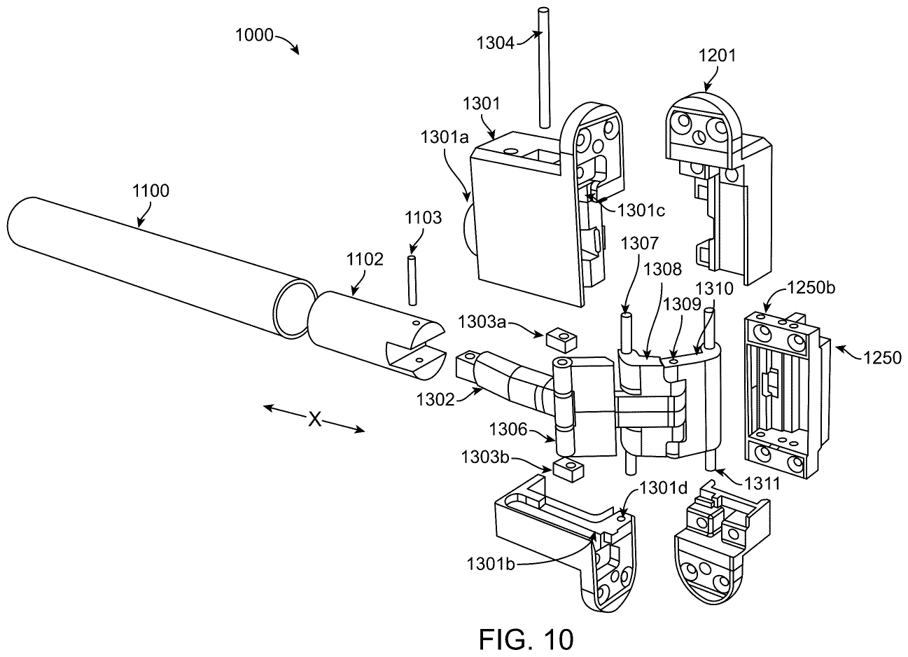

With reference to FIG. 10, another embodiment of concealed actuator 1000 is presented. Moveable element connector 1301 may include first lever 1302, interconnected levers 1306, 11360, and 1310, two or more sliders 1303a and 1303b, and 5 pins 1103, 1304, 1307, 1309, and 1311. Interconnected levers 1306, 11360, and/or 1310 may allow for up to 3 or more degrees of freedom between moveable element connector 1301 and actuator body element 1250. Sliding element 1102 at an output of a linear actuator 1100 may be connected to first lever 1302 by first rotating joint 1103. First lever 1302 may be connected to a first interconnected lever 1306 by second rotating joint 1304 and/or corresponding cavities in the two parts. Second rotating joint 1304 may be anchored to one or more sliders 1303a, 1303b which may slide on one or more rails 1301b, 1301c, allowing second rotating joint 1304 to translate along a given path which may be parallel to a principal axis of the linear actuator 1101, or at an angle to a principal axis of linear actuator 1101. First interconnected lever 1306 may be connected to second interconnected lever 11360 and/or to third interconnected lever 1310 through one or more joints, such as, but not limited to, third rotating joint 1309. Second interconnected lever 11360 may be connected to moveable element connector 1301 through fourth rotating joint 1304, which may be inserted into hole 1301d. The third actuator lever 1310 is connected to the actuator body 1250 by means of a fifth rotating joint 1311, 1250b.

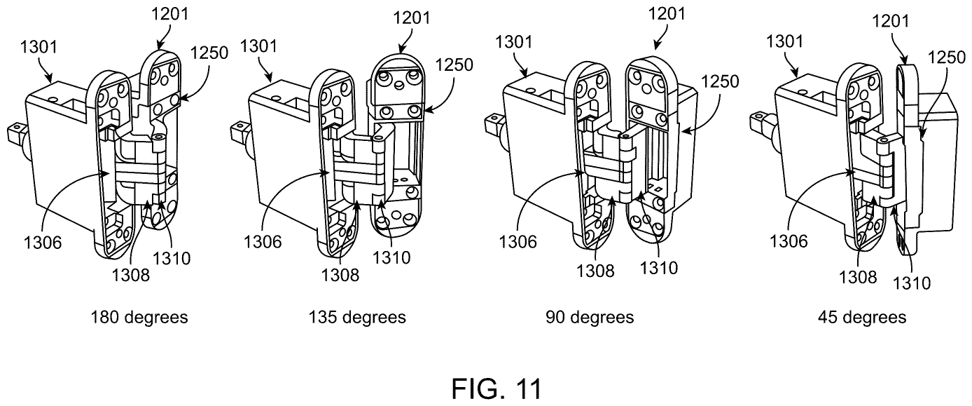

Referring now to FIG. 11, concealed actuator 1000 at various angles of rotation is presented. When a door is in a closed position, third interconnected lever 1310 may reside inside of actuator body element 1250. First interconnected lever 1306 and/or second interconnected lever 1360 may reside inside of moveable element connector 1301. First lever 1302 may retract towards a linear actuator. If a door trajectory is constrained by means of hinges, when a linear actuator retracts first lever 1302, the system of levers 1306, 1360, and/or 1310 may cause the door to close, while a force from the linear actuator that pushes the first lever 1302 away from the linear actuator may cause the door to open. In the absence of door hinges, the system of levers may not impose a specific axis of rotation on a door, which may allow the system of levers 1306, 1360, and/or 1310 to adapt to open and close doors with a variety of different types of hinges that are characterized by different positions of rotational axes or that constraint the door to move a long a trajectory that is composed of rotation and translation components.

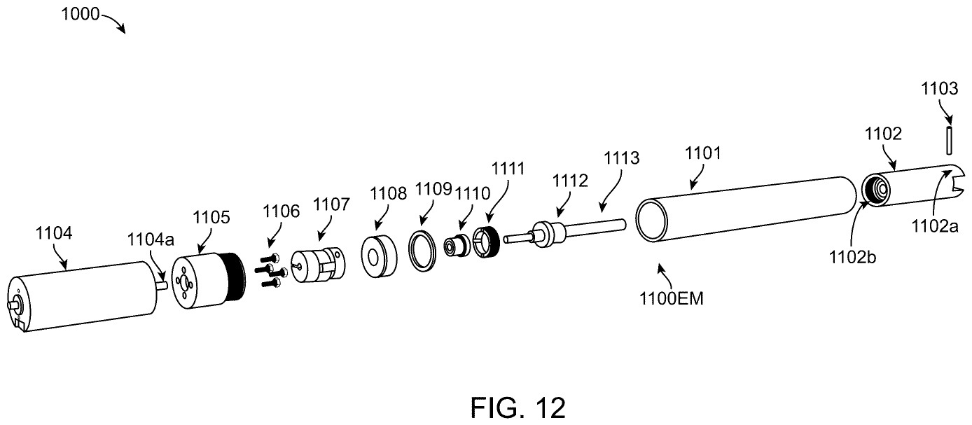

Referring now to FIG. 12, an exploded view of concealed actuator 1000 is shown. Concealed actuator 1000 may include linear actuator 1100M. Linear actuator 1100M may be an electromechanical actuator, hydraulic actuator, or other type of actuator. A hydraulic linear actuator may include an electrically controlled pump coupled with a hydraulic piston. Linear actuator 1100M may include rotary motor 1104. Rotary motor 1104 may provide electrical to mechanical power conversion for the actuation of concealed actuator 1000. Rotary motor 1104 may have output shaft 1104a. Output shaft 1104a may connect to motor body 1105. Motor body 1105 may connect to rotary motor 1104 via screws 1106. Motor body 1105 may be connected to mechanical joint 1107. Mechanical joint 1107 may be connected to ball bearing 1108. Ball bearing 1108 may be connected to snap ring 1109.

Linear actuator 1100M may include ball screw 1113, ball screw nut 1112, and/or ball bearing 1108. Bushing 1110 may center ball screw with an inner ring of ball bearing 1108. Ring 1111 may screw into threaded section 1102b of sliding element 1102, which may lock ball screw nut 1112 so that ball screw nut 1112 is fixed with sliding element 1102. Ball screw 1113, ball screw nut 1112, and/or ball bearing 1108 may convert a rotary motion of rotary motor 1104 into a linear motion. Rotary motor 1104 may be a direct current (DC) brushless or other motor. Rotary motor 1104 may include a shaft connected to a ball screw 1113. Pull and push forces exerted on ball screw 1113 during movement of a door may be axially supported by ball bearing 1108. Ball bearing 1108 may be fixed to motor body 1105 in which a snap ring 1108 or other mechanical support capable of counteracting the same axial load of screw 1113. In some embodiments, a drive shaft and ball screw 1113 may be connected by a mechanical joint which may allow for smaller axial misalignments relative to a connection without a mechanical joint. A joint may be anchored to a shaft of rotary motor 1104. Sliding element 1102 may slide inside tubular body 1101. Sliding element 1102 may be rigidly fixed to recirculating ball screw nut 1112. Sliding element 1102 may have hole 1102a which may allow for insertion of pin 1103.

In some embodiments, a ball screw nut 1113 with a small pitch may be used to obtain a high reduction ratio between an angular displacement of rotary motor 1104 and the angular displacement of a door, which may provide for high actuation torque with a smaller rotary motor 1104, which may also provide for a high reverse efficiency. A high reverse efficiency may enable users to interact with a door with a feeling of a normal, non-actuated door, when the actuator is disabled. The use of a small pitch may also prevent the use of any additional reduction stages, which may result in silent operation of the device. In some embodiments, a lead screw and nut may be used instead of ball screw nut 1113. A lead screw may have a large pitch and may have multiple starts to make the lead screw reversible. In some embodiments, a screw nut may be used with a lead screw. A screw nut may be made of a low friction material such as plastic, bronze, or other material to make a lead screw reversible. In some embodiments, a lead screw may be accompanied by one or more stages of reduction between rotary motor 1104 and the lead screw. As a non-limiting example, one or more multiple epicyclical stages of reduction may be employed. In other embodiments, linear actuator 1100EM may be a hydraulic linear actuator that may be used to translate a joint composed of first lever 1302 or an equivalent joint.

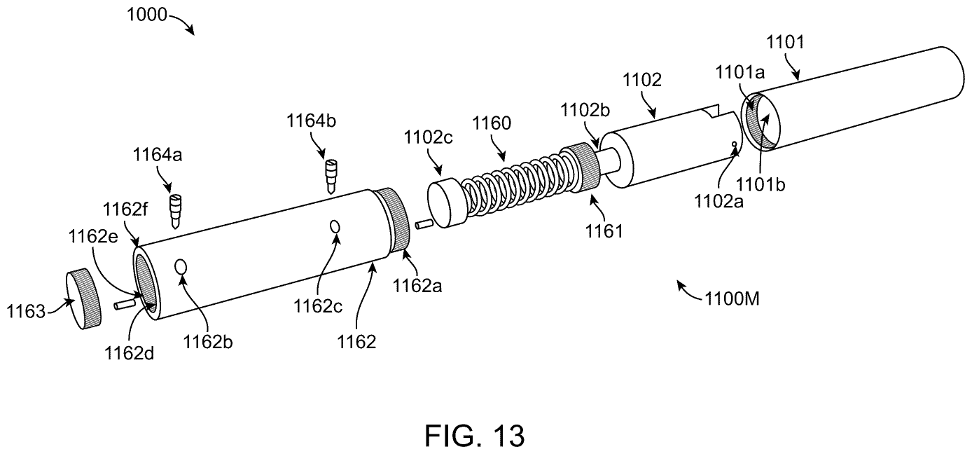

With reference to FIG. 13, an exploded view of an embodiment of concealed actuator 1000 is presented. Concealed actuator 1000 may include a mechanical linear actuator 1100M. Mechanical linear actuator 1100M may include spring 1160 and/or a damper system. Mechanical linear actuator 1100M may include cylindrical sliding element 1102, which may be connected to one or more actuation levers in moveable element connector 1301 by means of a joint, such as a joint composed by a cylindrical pin and a corresponding cavity 1102a in sliding element 1102. Sliding element 1102a may slide inside of body 1101 of concealed actuator 1000. Body 1101 may be a tubular body that may be rigidly connected to damping body 1162 of a hydraulic damping mechanism. Body 1101 may be connected to damping body 1162 through one or more threaded elements, such as threaded elements 1162a and 1101a. Dampening body 1162 may be a cylindrical or tubular shape. Dampening body 1162 may be made out of aluminum or other materials.

Dampening body 1162 may have an opening. An opening of dampening body 1162 may be cylindrical or other shapes. In some embodiments, an opening of dampening body 1162 may be offset with respect to a center of dampening body 1162. An offset of dampening body 1162 may provide space on one side of dampening body 1162 for canal 1162d and/or 1162f, each of which may be positioned on sides of an end of dampening body 1162. An oil canal of dampening body 1162, such as canals 1162d and/or 1162f, may be closed at both ends of dampening body 1162 through hydraulic valves 1164a and 1164b. One or more threaded holes 1162b, 1162c in dampening body 1162 may fit one or more hydraulic valves 1164a, 1164b which may regulate an oil flux providing tuning of main speed, backcheck, and latching speed. Threaded cylindrical element 1163 may seal a main cylindrical cavity of dampening body 1162 on one end through threaded end portion 1162e of dampening body 1162. A second threaded cylindrical element 1161 with a cylindrical window may seal a second end of dampening body 1162 which may allow a piston stem 1102b to slide along an actuator main axis and retain oil within a main cavity of dampening body 1162. A piston stem may be connected rigidly to piston head 1102c and/or to sliding element 1102. A piston head may slide inside of a main cavity of dampening body 1162. A spring may be located around a piston stem and may be compressed between piston head 1102c and threaded cylindrical element 1161. In some embodiments, when a door operator opens a door panel, one or more levers in moveable element connector 1301 may cause sliding element 1102 to move away from mechanical linear actuator 1100M, which may compress spring 1160. When an operator releases a door panel, spring 1160 may retract sliding element 1102, which may cause the door to close and piston head 1102c to slide within a main cavity of dampening body 1162, dampening an effect of spring 1160.

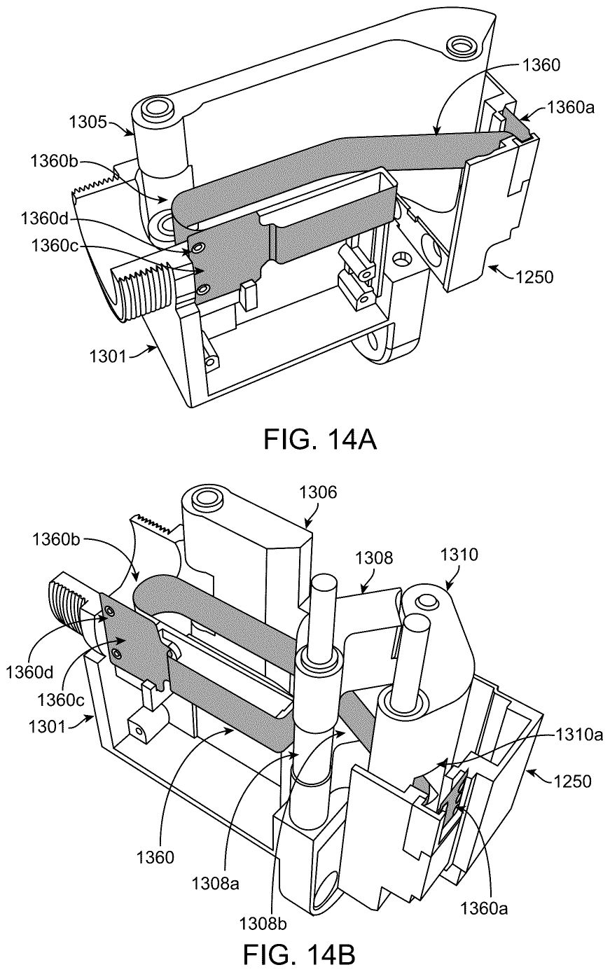

Referring now to FIG. 14A, a top perspective view of an embodiment of electrical connections within a moveable element connector is presented. Moveable element connector 1301 and one or more levers may be shaped to allow a passage of electric cable 1360 invisibly to an outside perspective. Electric cable 1360 may provide power for powering a motor, control electronics, and/or a passage of digital or analog configuration and control data. Electric cable 1360 may have a thickness of about 0.1 mm to about 2 mm, greater than about 2 mm, or less than about 0.1 mm. Electric cable 1360 may have a plurality of wires running parallel to each other. Electric cable 1360 may be routed through moveable element connector 1301. A space between second lever 1305 and moveable element connector 1301 may be large enough to allow electric cable 1360 to pass through it in both closed and open door positions. In some embodiments, second lever 1305 may have an opening angle of up to or greater than about 140 degrees, which electric cable 1360 may be flexible enough to withstand tension or other forces of a movement of second lever 1305.

In some embodiments, electric cable 1360 may have two or more folds 1360b, which may allow electric cable 1360 to extend and retract within a range that corresponds to a range of motion of second lever 1305, for example, but not limited to, about 80 mm to about 100 mm, greater than about 100 mm, or less than about 80 mm. Electric cable 1360 may have one or more holes, such as hole 1360d, which may allow for a screw or other securing element to anchor electrical cable 1360 to moveable element connector 1301. Electric cable 1360 may have varying dimensions. For instance, electric cable 1360 may surface area 1360c, which may be thicker than one or more parts of a length of electric cable 1306. Surface area 1360c may provide support to anchoring of electric cable 1360 to moveable element connector 1301 via hole 1360d.

A range of motion of second lever 1305 may provide for a use of concealed actuator 1000 in doors with hinges that are far away from the actuator, for example in thick doors or when hinges with axis of rotation that are external to the door panel. In some embodiments, a positioning of electric cable 1360 within moveable element connector 1301 may allow for a small curvature radius of electric cable 1360 in all door positions, allowing a long length of the electric cable 1360 to be used. Electric cable 1360 may be encased or in other way attached to a flexible material that protects electric cable 1360, such as, but not limited to, mylar, PVC, or other materials that can withstand a large number of flexion movements. Electric cable 1360 may be a flat-flexible-cable printed circuit board (FFC-PCB) in some embodiments.

Referring now to FIG. 14B, another top perspective view of an embodiment of electrical connections within a moveable element connector is presented. Electric cable 1360 may fold at folded portions 1360a,b Electric cable 1360 may pass through window 11360b located within second interconnected lever 11360, and through second window 1310a within third interconnected lever 1310. A space between levers 11360 and 1310 may be dimensioned to accommodate electric cable 1360 passing through in both closed and open door positions, ensuring minimal flexion even at a maximum opening angle of 180 degrees.

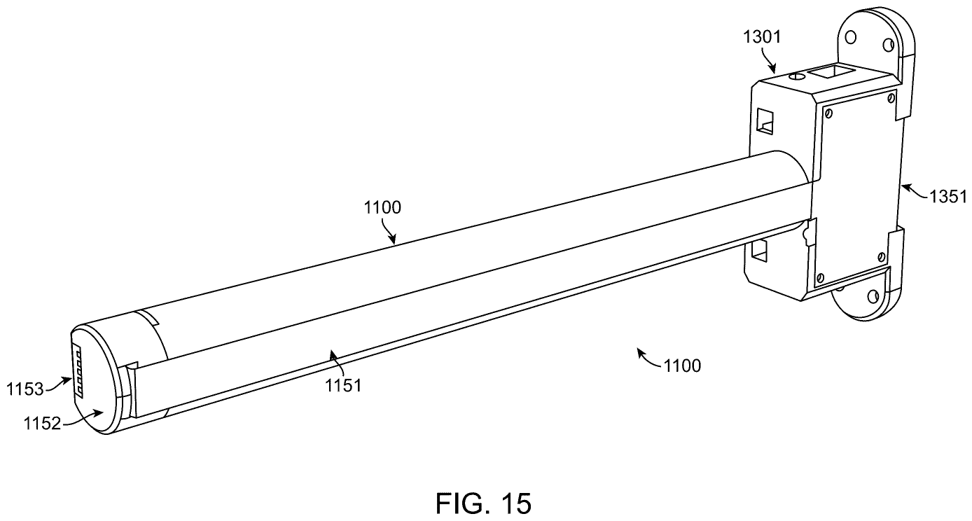

Referring now to FIG. 15, another embodiment of concealed actuator 1000 is presented. Electrical connector 1153 may be anchored to a support element, which may be secured to linear actuator 1100. A thin flat cable 1151 may be glued or otherwise attached to a body of linear actuator 1100, which may enable a routing of cables through linear actuator 1000, allowing linear actuator 100 to serve as a conduit for both power and signal transmission. Linear actuator 1100 may be utilized to route electrical power and signals between any electrical components within the door panel and external elements, facilitating seamless integration of the door with external control or power sources. A thin wire, such as for example a flat-flexible-cable printed circuit board (FFC-PCB) may be utilized, which may allow a profile of linear actuator 1100 body to remain essentially cylindrical and therefore to be hosted in a cylindrical opening in the door panel.

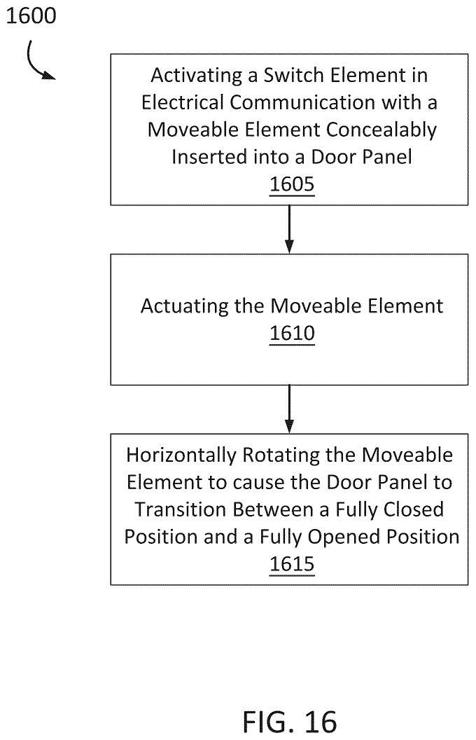

Referring now to FIG. 16, a method of automatically operating a swing door is presented. At step 1605, method 1600 includes activating a switch element in electrical communication with a moveable element concealably inserted into a door panel. A switch element may include, but is not limited to, a physical button, GUI icon, or other elements. For instance, a user may press a button that may be wired to or wirelessly connected to one or more processors in communication with the moveable element. In some embodiments, a switch element may include a proximity sensor, which may detect a distance between one or more individuals and a door panel. A switch element may provide one or more commands to one or more processors in communication with a moveable element. This step may be implemented as described above with reference to FIGS. 1-15, without limitation.

At step 1610, method 1600 includes actuating the moveable element. The moveable element may include a linear actuator, which may be actuated based on an activation of a switch element. An actuator of the moveable element may cause the moveable element to provide a push or pull force on one or more levers and/or hinges connected a door panel to a door frame. One or more levers and/or hinges may translate a push or pull force from the moveable element into a horizontal rotation. This step may be implemented as described above with reference to FIGS. 1-15, without limitation.

At step 1615, method 1600 includes horizontally rotating the moveable element to cause the door panel to transition between a fully closed position and a fully opened position. The moveable element may horizontal rotate in response to a movement of one or more levers and/or hinges mechanically connected to the moveable element. For instance, the moveable element may provide a push or pull force that may cause one or more levers and/or hinges to rotate horizontally relative to a door frame of the door panel. A rotation of one or more levers and/or hinges may cause the moveable element to horizontally rotate, which may cause the door panel to horizontally rotate. For instance, the moveable element may provide a torque to the door panel. The door panel may horizontally rotate between a fully closed position, which may be a position in which the door panel is horizontally aligned with a door frame, to a fully open position, which may be a position in which the door panel is aligned perpendicular to the door frame. In some embodiments, a speed at which the door panel may be horizontally rotated may be controlled. For instance, one or more processors may be programmed to horizontally rotate the moveable element at a rate of about 1 degree per second to about 5 degrees per second, greater than about 5 degrees per second, or less than about 1 degree per second. This step may be implemented as described above with reference to FIGS. 1-15, without limitation.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

What is claimed is:

1. An actuator for swing doors, comprising:
a moveable element having a proximal end and a distal end, the distal end concealably insertable into a door panel and configured to horizontally rotate the door panel;
a base configured to adhered to a door frame;
a moveable hinge coupled to the proximal end of the moveable element and the base, wherein the moveable hinge is configured to pivot with the horizontal rotation of the door panel; and
an electrical connector concealably positioned with respect to the moveable hinge, the electrical connector passing from the base to the proximal end of the moveable element.

2. The actuator of claim 1, wherein the moveable element is configured to horizontally rotate between about 0 degrees to about 180 degrees with respect to the door frame.

3. The actuator of claim 1, wherein the electrical connector includes a plurality of electrical wires running positioned in parallel with each other to provide power from a power source to the moveable element.

4. The actuator of claim 1, further comprising a moveable element connector connecting the proximal end to the base, the moveable element connector comprising a printed circuit board (PCB) in electrical communication with the electrical connector.

5. The actuator of claim 1, wherein the moveable element is inserted into a center of rotation of the door panel.

6. The actuator of claim 1, wherein the electrical connector is flexible and horizontally rotates with the horizontal rotation of the moveable element.

7. The actuator of claim 1, wherein the moveable hinge further comprises a first window positioned near the proximal end of the moveable element and a second window positioned near the base, wherein the electrical connector passes through both the first and second windows.

8. The actuator of claim 1, wherein the electrical connector is encased in a protective material.

9. The actuator of claim 1, wherein the horizontal rotation of the door panel transitions the door panel between a fully closed and a fully opened position.

10. The actuator of claim 1, wherein the moveable element is a reversible linear actuator.

11. A method of automatically operating a swing door, comprising:
activating a switch element in electrical communication with a moveable element, the moveable element concealably inserted into a door panel;
actuating the moveable element in response to the activation of the switch element, wherein the moveable element is connected to a base attached to a door frame through a moveable hinge coupled to the base; and
horizontally rotating the moveable element and the moveable hinge relative to the base to cause the door panel to transition between a substantially closed position and a substantially opened position.

12. The method of claim 11, wherein the moveable element is inserted into a center of rotation of the door panel.

13. The method of claim 11, wherein the moveable element is a reversible linear actuator.

14. The method of claim 11, wherein the moveable element is horizontally rotatable between about 0 degrees to about 180 degrees.

15. The method of claim 11, further comprising providing power to the moveable element from an external power source through an electric cable.

16. The method of claim 15, wherein the electric cable is routed within one or more levers connected to the moveable element.

17. The method of claim 15, wherein the electric cable providers power to the moveable element through one or more spring contacts.

18. The method of claim 15, wherein the electric cable is concealed from an outside perspective view of a user.

19. The method of claim 11, wherein the moveable element is horizontally rotated at a constant speed.

20. The method of claim 11, wherein the moveable element is horizontally rotated at first rate of a change in degrees per second initially followed by a second rate of a change in degrees per second, the second rate being lower than the first rate.
